(19) United States
(12) Patent Application Publication
(10) Pub. No.: US 2025/0352985 A1
(43) Pub. Date: Nov. 20, 2025

(54) METHOD FOR PRODUCING VOC ADSORPTION DEVICE

(71) Applicant: Murata Manufacturing Co., Ltd., Nagaokakyo-shi (JP)

(72) Inventors: Yukio SANADA, Nagaokakyo-shi (JP); Akira TANAKA, Nagaokakyo-shi (JP)

(21) Appl. No.: 19/286,329

(22) Filed: Jul. 31, 2025

Related U.S. Application Data
(63) Continuation of application No. PCT/JP2024/003480, filed on Feb. 2, 2024.

(30) Foreign Application Priority Data
Feb. 7, 2023 (JP) 2023-016642

(51) Int. Cl. B01J 20/30; B01D 53/02; B01J 20/10; B01J 20/20; B01J 20/28; B01J 20/32

(52) U.S. Cl. CPC B01J 20/305; B01D 53/02; B01J 20/10; B01J 20/20; B01J 20/28042; B01J 20/3042; B01J 20/3204; B01D 2257/708

(57) ABSTRACT

A method for producing a VOC adsorption device, the method including: mixing a VOC adsorption material, a solvent, a binder, and resin beads to form a slurry; coating the slurry on a substrate; and firing the substrate coated with the slurry at a temperature higher than a thermal decomposition temperature of the resin beads.

### CROSS REFERENCE TO RELATED APPLICATIONS

The present application is a continuation of International application No. PCT/JP2024/003480, filed Feb. 2, 2024, which claims priority to Japanese Patent Application No. 2023-016642, filed Feb. 7, 2023, the entire contents of each of which are incorporated herein by reference.

### TECHNICAL FIELD

The present disclosure relates to a method for producing a device which adsorbs VOC.

### BACKGROUND ART

A VOC adsorption device is usually known, which adsorbs a volatile organic compound (VOC: Volatile Organic Compound, referred to as “VOC” hereinafter) such as toluene, ethyl acetate, or the like. The VOC adsorption device includes a substrate supporting an adsorption material which adsorbs VOC. Patent Document 1 discloses a vapor treatment apparatus including a honeycomb-type VOC adsorption rotor as one of such VOC adsorption devices.
Patent Document 1: Japanese Unexamined Patent Application Publication No. 2016-77969

### SUMMARY OF THE DISCLOSURE

The surface area of the adsorption material used in a VOC adsorption device is increased by making the particles fine, and thus the VOC adsorption efficiency is improved. However, when the particles constituting the adsorption material is made fine, a gas to be treated, which contains VOC, hardly reaches the inside of the adsorption material due to small gaps between the particles, thereby decreasing the treatment efficiency of the adsorption material.

The present disclosure solves the problem described above and an object thereof is to provide a method for producing a VOC adsorption device including an adsorption material which allows gas to be treated to easily reach also the inside thereof.

A method for producing a VOC adsorption device of the present disclosure includes: mixing a VOC adsorption material, a solvent, a binder, and resin beads to form a slurry; coating the slurry on a substrate; and firing the substrate coated with the slurry at a temperature higher than a thermal decomposition temperature of the resin beads.

According to the method for producing a VOC adsorption device of the present disclosure, the resin beads contained in the slurry are disappeared by firing the substrate coated with the slurry at a temperature higher than the thermal decomposition temperature of the resin beads, and thus gaps can be intentionally formed in the adsorption material supported by the substrate of the produced VOC adsorption device. Therefore, a gas to be treated easily reaches the inside of the adsorption material, and thus more VOC can be adsorbed by the adsorption material, thereby improving the treatment efficiency of the adsorption material.

### BRIEF DESCRIPTION OF THE DRAWINGS

FIG. 1 is a perspective view schematically showing the configuration of a VOC adsorption rotor according to an embodiment.

FIG. 2 is a plan view schematically showing the configuration of a VOC adsorption rotor according to an embodiment, as viewed from the extension direction of the rotational axis.

FIG. 3 is a flowchart for explaining a method for producing a VOC adsorption device.

FIG. 4 (a) is a drawing schematically showing an adsorption material and resin beads contained in a slurry coated on a substrate in the process of Step S2 shown in FIG. 3, and FIG. 4 (b) is a drawing schematically showing an adsorption material contained in a usual slurry coated on a substrate.

FIG. 5 is a diagram observed for a slurry coated on a substrate with a scanning electron microscope.

FIG. 6 is a drawing schematically showing the configuration of an adsorption material after firing.

### DESCRIPTION OF THE PREFERRED EMBODIMENTS

The features of the present disclosure are specifically described below by giving an embodiment of the present disclosure.

A description is made below of an example of the configuration of a VOC adsorption device produced by a method for producing a VOC adsorption device of the present disclosure, and then a method for producing a VOC adsorption device is described. Herein, the VOC adsorption device is described as a VOC adsorption rotor. However, the VOC adsorption device which adsorbs VOC is not limited to the VOC adsorption rotor, and it preferably has a configuration in which an adsorption material is supported by a substrate.

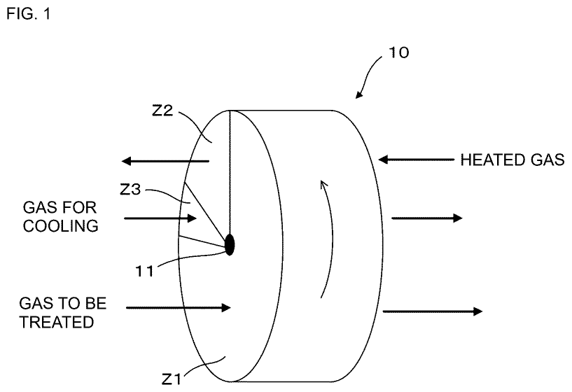

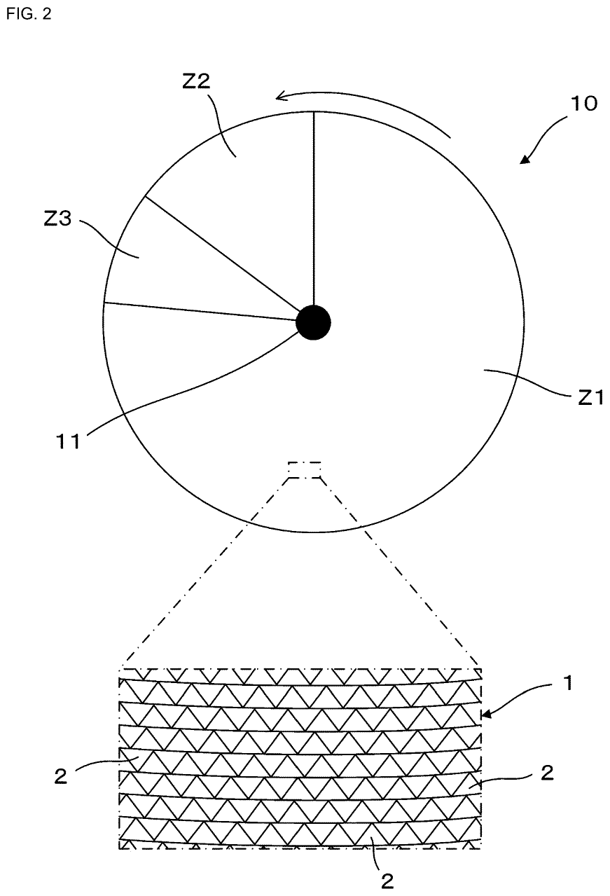

FIG. 1 is a perspective view schematically showing the configuration of a VOC adsorption rotor 10 according to an embodiment. FIG. 2 is a plan view schematically showing the VOC adsorption rotor 10 according to an embodiment as viewed from the extension direction (also referred to as the “rotational axis direction” hereinafter) of the rotational axis 11.

The VOC adsorption rotor 10 is configured to be rotatable around the rotational axis 11 using a motor as a driving source. The diameter of the VOC adsorption rotor 10 is, for example, 500 mm to 2000 mm, and the dimension in the extension direction of the rotational axis 11 is, for example, 200 mm to 800 mm.

The VOC adsorption rotor 10 includes a substrate 1 which supports an adsorption material for adsorbing VOC (a “VOC adsorption material”). Herein, the substrate 1 is described as a honeycomb structure having a honeycomb shape. However, the substrate 1 is not limited to the honeycomb structure. The substrate 1 is composed of a metal such as stainless steel or the like. However, the material constituting the substrate 1 is not limited to a metal, and ceramic, incombustible paper such as ceramic fiber paper or the like, or the like may be used.

The shape of a plurality of cells 2 constituting the honeycomb structure may be any desired shape. In the example shown in FIG. 2, the shape of the cells 2 is a triangular shape as viewed from the extension direction of the rotational axis 11. However, the shape of the cells 2 as viewed from the rotational axis direction may be another shape such as a hexagonal shape, a rectangular shape, or the like.

The adsorption material supported by the substrate 1 may be any material as long as it can adsorb VOC contained in a gas to be treated, and usable examples thereof include porous materials such as zeolite, activated carbon, silica, and the like. The gas to be treated is, for example, a gas containing VOC generated by treatment such as washing, printing, coating, drying, and the like in a factory. Examples of VOC include aromatic compounds such as benzene, toluene, and the like; ketones such as acetone, methyl ethyl ketone, and the like; esters such as ethyl acetate, butyl acetate, and the like; chlorocarbons such as trichlene, methylene chloride, and the like; alcohols such as methanol, isopropyl alcohol, and the like; and the like. In addition, the present disclosure is not limited by the type of VOC to be removed and the type of the adsorption material.

A catalyst for decomposing VOC may be supported by the substrate 1. For example, platinum, palladium, or the like can be used as the catalyst for decomposing VOC.

In the present disclosure, the adsorption material supported by the substrate 1 is formed as a sparse film having may gaps. The diameter of the particles constituting the adsorption material is, for example, 5 μm or less. When the diameter of the particles constituting the adsorption material is 5 μm or less, the surface area of the whole of the adsorption material is increased, and thus the efficiency of VOC adsorption is improved.

As shown in FIG. 1 and FIG. 2, the VOC adsorption rotor 10 includes an adsorption zone Z1, a desorption zone Z2, and a cooling zone Z3 which are provided along the rotation direction. The adsorption zone Z1 is a region for passing the gas to be treated and adsorbing VOC contained in the gas to be treated. The desorption zone Z2 is a region for desorbing the VOC adsorbed in the adsorption zone Z1. In order to desorb VOC, a heated gas is passed through the desorption zone Z2. The cooling zone Z3 is a region for cooling the substrate 1 heated in the desorption zone Z2. A gas for cooling the substrate 1 is passed through the cooling zone Z3.

In FIG. 2, when the VOC adsorption rotor 10 is rotated counterclockwise, cells 2 located in the adsorption zone Z1 are moved to the desorption zone Z2 and the cooling zone Z3 in this order, and then returned to the adsorption zone Z1. Cooling the substrate 1 in the cooling zone Z3 enables to adsorb again VOC in the adsorption zone Z1.

That is, the rotation of the VOC adsorption rotor 10 causes repeated adsorption and desorption of VOC contained in the gas to be treated. When the catalyst for decomposing VOC is supported by the substrate 1, decomposition reaction of VOC is brought about in the desorption zone Z2, but the adsorbed VOC can be considered as being desorbed by VOC decomposition, and thus VOC decomposition is included in VOC desorption. The rotational speed of the VOC adsorption rotor 10 is, for example, 8.4rph to 11.0 rph.

As described above, in the embodiment, the substrate 1 of the VOC adsorption rotor 10 is composed of a metal, and thus can conduct electricity. Therefore, in the desorption zone Z2, the substrate 1 can be heated directly by applying electrical current to generate Joule heat. This can decrease the amount of energy for desorbing VOC. That is, in comparison with a usual VOC adsorption rotor in which VOC adsorbed by the substrate 1 is desorbed by only passing heated gas through the desorption zone Z2, the heating efficiency is improved, and the adsorbed VOC can be desorbed with high energy efficiency. For example, the heating temperature of a gas to be passed through the desorption zone Z2 in order to desorb the VOC adsorbed in the adsorption zone Z1 can be decreased as compared with the usual VOC adsorption rotor described above.

(Method for producing VOC adsorption device)

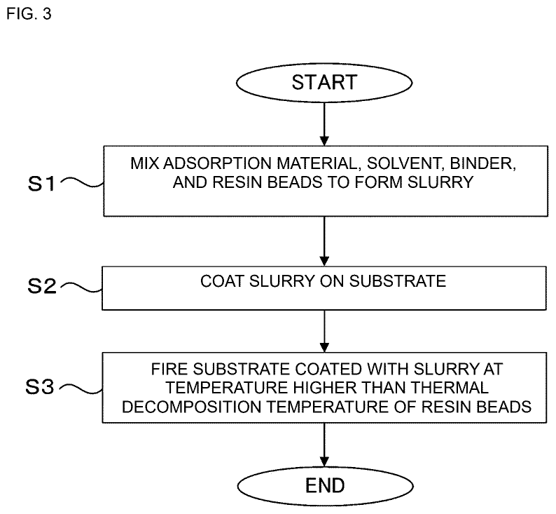

FIG. 3 is a flow chart for explaining a method for producing a VOC adsorption device. Herein, the produced VOC adsorption device is described as the VOC adsorption rotor 10.

In Step S1, an adsorption material capable of adsorbing VOC, a solvent, a binder, and resin beads are mixed to form a slurry. Usable examples of the adsorption material include zeolite, activated carbon, silica, and the like. For example, water can be used as the solvent. Usable examples of the binder include organic sols having certain compatibility with the solvent, such as polyvinyl alcohol (PVA), water-soluble cellulose, and the like; and metal sols such as alumina sol, and the like.

In the embodiment, the resin beads are composed of at least one selected from the group including an acrylic resin, a polyethylene resin, and a polypropylene resin. A plurality of types of resin beads may be used as the resin beads for forming a slurry. However, the resin beads may be composed of a resin other than an acrylic resin, a polyethylene resin, or a polypropylene resin. The shape of the resin beads is, for example, a spherical shape. However, the shape of the resin beads is not limited to a spherical shape.

The diameter of the resin beads is preferably 0.5 times to 5 times of the diameter of the particles constituting the adsorption material. When the diameter of the resin beads is less than 0.5 times of the diameter of the particles constituting the adsorption material, the gaps in the adsorption material supported by the substrate 1 of the produced VOC adsorption rotor 10 become small, and thus the gas to be treated hardly reach the inside of the adsorption material. While when the diameter of the resin beads is more than 5 times of the diameter of the particles constituting the adsorption material, it becomes difficult to form a film of the adsorption material on the substrate 1.

The ratio of the resin beads to the total of the adsorption material and the resin beads contained in the slurry is preferably 10% by volume to 50% by volume and more preferably 30% by volume. When the ratio of the resin beads to the total of the adsorption material and the resin beads is lower than 10% by volume, the gaps in the adsorption material supported by the substrate 1 of the produced VOC adsorption rotor 10 become small, and thus the gas to be treated hardly reach the inside of the adsorption material. While when the ratio of the resin beads to the total of the adsorption material and the resin beads is higher than 50% by volume, it becomes difficult to form a film of the adsorption material on the substrate 1.

In Step S2 subsequent to Step S1, the formed slurry is coated on the substrate 1. The slurry is coated by, for example, dipping.

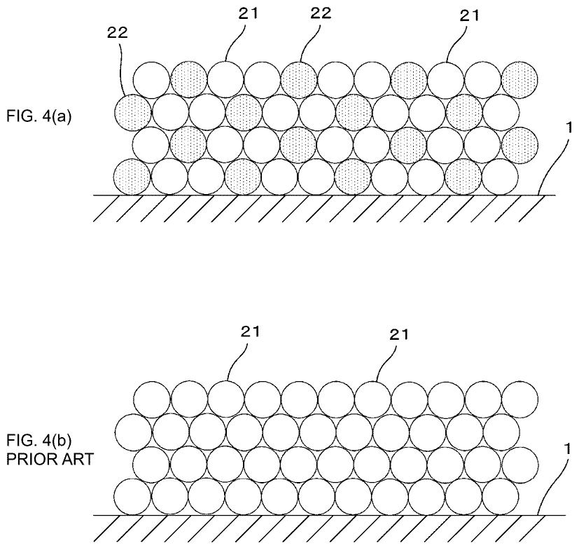

FIG. 4 (a) is a drawing schematically showing an adsorption material and resin beads 22 contained in a slurry coated on the substrate 1 in Step S2. FIG. 4 (b) is a drawing schematically showing an adsorption material contained in a usual slurry coated on the substrate 1. The usual slurry contains an adsorption material, a solvent, and a binder, but not contains resin beads. As shown in FIG. 4 (a), the resin beads 22 are present between the particles 21 constituting the adsorption material in the slurry used in the method for producing a VOC adsorption device of the present disclosure. The resin beads 22 are dispersed in the slurry. On the other hand, when the usual slurry not containing resin beads is coated, the particles 21 constituting the adsorption material are densely present as shown in FIG. 4 (b).

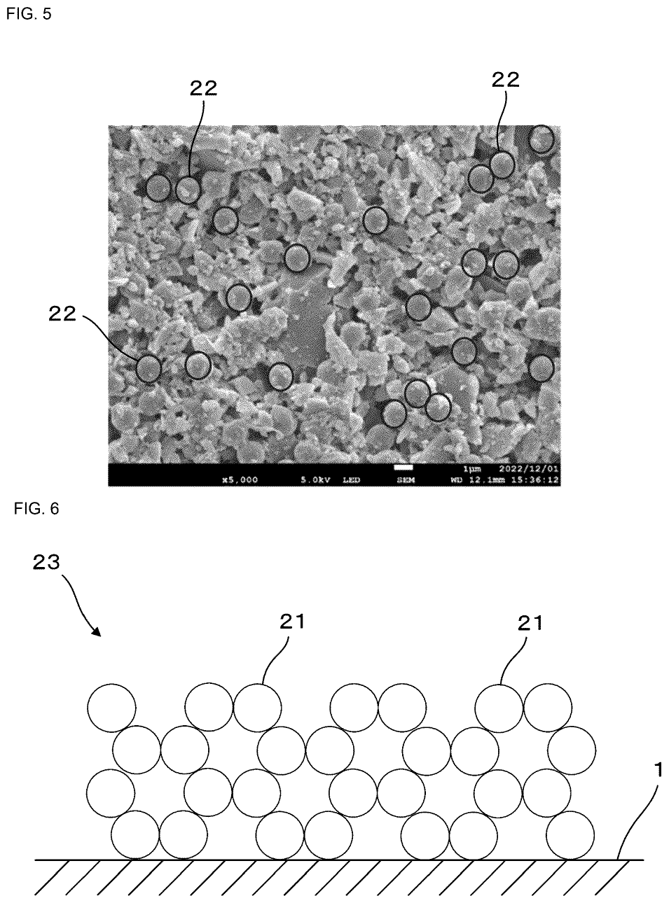

FIG. 5 is a diagram observed for a slurry coated on the substrate 1 with a scanning electron microscope (SEM). The observation magnification is 5000 times. In FIG. 5, some of the many resin beads 22 contained in the slurry are circled and shown. As shown in FIG. 5, it can be confirmed that the resin beads 22 are dispersed in the slurry coated on the substrate 1.

In Step S3 subsequent to Step S2 in the flowchart shown in FIG. 3, the substrate 1 coated with the slurry is fired at a temperature higher than the thermal decomposition temperature of the resin beads 22. For example, when the resin beads 22 are composed of an acrylic resin, the substrate 1 coated with the slurry is fired at a temperature of 300° C. or more because the thermal decomposition temperature of the acrylic resin in an air atmosphere is lower than 300° C. When the substrate 1 is fired at a temperature higher than the thermal decomposition temperature of the resin beads 22, the resin beads 22 contained in the slurry are decomposed and disappeared.

FIG. 6 is a drawing schematically showing the configuration of the adsorption material 23 after firing. As shown in FIG. 6, the resin beads 22 contained in the slurry are disappeared, and thus many gaps are present between the particles 21 constituting the adsorption material 23. That is, the adsorption material 23 supported by the substrate 1 is formed as a sparse film having many gaps. Therefore, the gas to be treated easily reaches not only the surface portion of the adsorption material 23 but also the inside thereof, and thus VOC contained in the gas to be treated can be more adsorbed by the adsorption material 23, thereby improving the treatment efficiency of the adsorption material 23. In addition, the inside of the adsorption material 23 represents a portion deeper in the direction to the substrate 1 than the surface portion of the adsorption material 23 formed as a film.

The VOC adsorption rotor 10 including the adsorption material 23 supported by the substrate 1 can be produced by the steps described above.

The present disclosure is not limited to the embodiment described above, and various applications and modifications can be made within the scope of the present disclosure.

### REFERENCE SIGNS LIST

1 substrate
2 cell
10 VOC adsorption rotor
11 rotational axis
21 particle constituting adsorption material
22 resin beads
23 adsorption material

1. A method for producing a VOC adsorption device, the method comprising:
mixing a VOC adsorption material, a solvent, a binder, and resin beads to form a slurry;
coating the slurry on a substrate; and
firing the substrate coated with the slurry at a temperature higher than a thermal decomposition temperature of the resin beads.

2. The method for producing a VOC adsorption device according to claim 1, wherein the firing of the substrate coated with the slurry is conducted until the resin beads contained in the slurry are decomposed and disappeared.

3. The method for producing a VOC adsorption device according to claim 1,
wherein the substrate is a honeycomb structure; and
the VOC adsorption device is a VOC adsorption rotor.

4. The method for producing a VOC adsorption device according to claim 1, wherein the resin beads comprise at least one selected from an acrylic resin, a polyester resin, and a polypropylene resin.

5. The method for producing a VOC adsorption device according to claim 4, wherein a diameter of the resin beads is 0.5 times to 5 times of a diameter of particles constituting the VOC adsorption material.

6. The method for producing a VOC adsorption device according to claim 5, wherein a ratio of the resin beads to a total of the VOC adsorption material and the resin beads contained in the slurry is 10% by volume to 50% by volume.

7. The method for producing a VOC adsorption device according to claim 5, wherein a ratio of the resin beads to a total of the VOC adsorption material and the resin beads contained in the slurry is 10% by volume to 30% by volume.

8. The method for producing a VOC adsorption device according to claim 5, wherein the diameter of the particles constituting the VOC adsorption material is 5 μm or less.

9. The method for producing a VOC adsorption device according to claim 1, wherein a diameter of the resin beads is 0.5 times to 5 times of a diameter of particles constituting the VOC adsorption material.

10. The method for producing a VOC adsorption device according to claim 9, wherein a ratio of the resin beads to a total of the VOC adsorption material and the resin beads contained in the slurry is 10% by volume to 50% by volume.

11. The method for producing a VOC adsorption device according to claim 9, wherein a ratio of the resin beads to a total of the VOC adsorption material and the resin beads contained in the slurry is 10% by volume to 30% by volume.

12. The method for producing a VOC adsorption device according to claim 9, wherein the diameter of particles constituting the VOC adsorption material is 5 μm or less.

13. The method for producing a VOC adsorption device according to claim 1, wherein a ratio of the resin beads to a total of the VOC adsorption material and the resin beads contained in the slurry is 10% by volume to 50% by volume.

14. The method for producing a VOC adsorption device according to claim 1, wherein a ratio of the resin beads to a total of the VOC adsorption material and the resin beads contained in the slurry is 10% by volume to 30% by volume.

15. The method for producing a VOC adsorption device according to claim 1, wherein a diameter of particles constituting the VOC adsorption material is 5 μm or less.

16. The method for producing a VOC adsorption device according to claim 1, wherein the substrate is composed of a metal.

17. The method for producing a VOC adsorption device according to claim 1, wherein the resin beads have a spherical shape.
